(19) United States
(12) Patent Application Publication
(10) Pub. No.: US 2020/0364080 A1
(43) Pub. Date: Nov. 19, 2020

(54) INTERRUPT PROCESSING METHOD AND APPARATUS AND SERVER

(71) Applicant: Huawei Technologies Co., Ltd., Shenzhen (CN)

(72) Inventors: Weiyan ZHENG, Hangzhou (CN); Shuying LEI, Shenzhen (CN)

(21) Appl. No.: 16/987,014

(22) Filed: Aug. 6, 2020

Related U.S. Application Data
(63) Continuation of application No. PCT/CN2018/100622, filed on Aug. 15, 2018.

(30) Foreign Application Priority Data
Feb. 7, 2018 (CN) 201810124945.2

(51) Int. Cl. G06F 9/48; H04L 12/861; H04L 29/08; G06F 9/50; G06F 9/4401; G06F 9/54

(52) U.S. Cl. CPC G06F 9/4812; H04L 49/9073; G06F 9/544; G06F 9/5027; G06F 9/4418; H04L 67/2842

(57) ABSTRACT

An interrupt processing method applied to a server including a plurality of cores, the plurality of cores include an interrupt processing core and a service processing core that runs a service process, and the method is implemented by the interrupt processing core and includes: receiving an interrupt processing request, where the interrupt processing request is used to request to process at least one of a plurality of TCP data packets of the service process that are stored in an interrupt queue, and destination ports of all of the plurality of TCP data packets correspond to a same interrupt queue; obtaining the at least one TCP data packet from the interrupt queue; determining the service processing core based on the at least one TCP data packet, where there is cache space shared by the interrupt processing core and the service processing core; and waking the service processing core.

### CROSS-REFERENCE TO RELATED APPLICATIONS

This is a continuation of International Application No. PCT/CN2018/100622, filed on Aug. 15, 2018, which claims priority to Chinese Patent Application No. 201810124945.2, filed on Feb. 7, 2018. The disclosures of the aforementioned applications are hereby incorporated by reference in their entireties.

### TECHNICAL FIELD

This disclosure relates to the field of data storage technologies, and in particular, to an interrupt processing method and apparatus, and a server.

### BACKGROUND

In a general-purpose computer structure, a cache is used to resolve a problem of a speed difference between a central processing unit (CPU) and memory. There are three levels of caches in total: a level 1 (L1 for short) cache, a level 2 (L2 for short) cache, and a level 3 (L3 for short) cache. Access priorities and access rates of the three levels of caches are successively as follows: L1>L2>L3. A data access rate can be improved by using different caches. When the CPU needs to read data, the cache is first searched for the to-be-read data. If the to-be-read data is found, the to-be-read data is immediately sent to the CPU for processing. If the to-be-read data is not found, the to-be-read data is read from the memory at a relatively low speed, and is sent to the CPU for processing. In addition, a data block in which the data is located is invoked into the cache, so that data in the entire block can be read from the cache subsequently, and the memory does not need to be invoked.

Currently, in a server architecture, each server may include one or more CPUs, each CPU includes a plurality of cores, and different CPU cores may share a cache resource. For example, an ARM server includes two CPUs, and each CPU includes 32 cores. In a same CPU, every four cores are grouped into one cluster, and every 16 cores are grouped into one logical unit (die). Each core in the CPU exclusively uses one L1 cache, four cores in one cluster share one L2 cache, and 16 cores in one logical unit share one L3 cache. In a service processing process, a core of a processor processes an input/output (I/O) operation request in an interrupt manner. A specific process is as follows: When a server receives a transmission control protocol (TCP) data packet carrying the I/O operation request, the TCP data packet is stored in an interrupt queue associated with the TCP data packet. One processor core (referred to as an interrupt processing core) is configured for each interrupt queue. The interrupt processing core sequentially obtains the TCP data packet in a first in first out manner, and instructs, to process the TCP data packet, a processor core (which is a core that runs a service process, and is referred to as a service processing core) that processes a service process corresponding to the TCP data packet. Then, the service processing core needs to read data from a cache or memory of the interrupt processing core, to complete data reading and writing. When the server includes a plurality of CPUs, and each CPU includes a plurality of cores, the interrupt processing core and the service processing core may not be in a same cluster or a same logical unit, and the interrupt processing core and the service processing core cannot share a cache resource. In this case, the interrupt processing core and the service processing core need to access caches in a cross-CPU or cross-logical unit manner by using an internal bus, resulting in a long processing time of reading or writing.

When the foregoing interrupt processing method is applied to a distributed data storage system, a plurality of pieces of replica data of same data may be stored on different servers. A server on which a virtual block system (VBS) process is deployed accesses replica data in a server on which an object storage device (OSD) process is deployed. A plurality of OSD processes may be deployed on each server. Each OSD process corresponds to one disk in the server, and each process is processed by one processor core. FIG. 1 is a schematic diagram of a distributed data storage system. As shown in FIG. 1, communication between a VBS process and each OSD process and communication between OSD processes on different servers each are performed through a TCP connection. In FIG. 1, that an OSD 1 to an OSD n represent the OSD processes on the different servers is used as an example for description. During data reading or writing, the VBS process first sends, in a form of payload data of a TCP data packet, to-be-read/written data to an OSD process in which master backup data is located. Then, the OSD process in which the master backup data is located synchronizes the data to another OSD process in which slave backup data is located. For an OSD process, the OSD process may receive a TCP data packet from the VBS process, or may receive a TCP data packet from an OSD process on another server. Therefore, the OSD process may receive a plurality of TCP data packets. Correspondingly, when a server receives a plurality of TCP data packets, the plurality of TCP data packets may be stored in a plurality of different interrupt queues. An interrupt processing core in each interrupt queue obtains a TCP data packet from the interrupt queue for processing, and stores data in the corresponding TCP data packet in a corresponding cache and memory. Because the interrupt processing core in the interrupt queue is randomly configured, a plurality of interrupt processing cores corresponding to the plurality of interrupt queues may be distributed in different logical units and different CPUs. In this case, a service processing core needs to read data from different caches and memory, and a delay existing when the service processing core accesses the memory and a delay existing when the service processing core accesses an L3 cache are longer than a delay existing when the service processing core accesses an L2 cache. In addition, the service processing core needs to access the cache and the memory in a cross-CPU or cross-logical unit manner by using an internal bus. This further increases the access delay. Therefore, the service processing core has a problem of a long data access delay. Consequently, a user data processing rate is reduced, and system performance is affected.

### SUMMARY

This disclosure provides an interrupt processing method and apparatus, and a server, to resolve prior-art problems of a long data access delay and a low user data processing rate.

To achieve the foregoing objective, the following technical solutions are used herein.

According to a first aspect, an interrupt processing method is provided, and is applied to a server of a central processing unit CPU including a plurality of cores. The CPU of the plurality of cores includes an interrupt processing core configured to process an interrupt, and a service processing core running a service process. The method includes the following: When the server receives a plurality of TCP data packets of the service process, because destination ports of all of the plurality of TCP data packets correspond to a same interrupt queue, the plurality of TCP data packets are stored in the interrupt queue, and an interrupt processing request is triggered. The interrupt processing core receives the interrupt processing request, where the interrupt processing request is used to request to process at least one of the plurality of TCP data packets stored in the interrupt queue, in other words, the interrupt processing request may be used to request to process one TCP data packet, or may be used to request to process a plurality of TCP data packets. The interrupt processing core obtains the at least one TCP data packet from the interrupt queue. The interrupt processing core may determine, based on TCP connection information of the at least one TCP data packet, the service process to which the at least one TCP data packet belongs, and the service process is run by the service processing core, so that the service processing core is determined. There is cache space shared by the interrupt processing core and the service processing core. The interrupt processing core may send a wake-up instruction to the service processing core, to wake the service processing core, so that the service processing core processes the at least one TCP data packet. For example, the service processing core updates, based on user data in the at least one TCP data packet, user data stored in the server, or sends the user data to another server to synchronize data.

In the foregoing technical solution, through configuration, a plurality of TCP connections of the service process in the server correspond to one interrupt queue, so that the plurality of TCP data packets received by the service process through the plurality of TCP connections may be stored in one interrupt queue. In addition, through configuration, there is same cache space between the interrupt processing core of the interrupt queue and the service processing core that runs the service process, so that the service processing core can use a shared cache to access data. This reduces a data access delay, and improves data processing efficiency, so that system performance is improved.

In a possible implementation, the interrupt processing core and the service processing core are a same core in one CPU. In this case, the service processing core may obtain the user data in the at least one TCP data packet from an L1 cache. A data access delay is the shortest, and a processing rate is the highest. Alternatively, the service processing core and the interrupt processing core belong to a same cluster (cluster). In this case, the service processing core may obtain the user data in the at least one TCP data packet from an L2 cache. A data access delay is relatively short, and a processing rate is relatively high. Alternatively, the service processing core and the interrupt processing core belong to a same logical unit (die). In this case, the service processing core may obtain the user data in the at least one TCP data packet from an L3 cache. Compared with those in memory access, a data access delay is relatively short, and a processing rate is relatively high.

In another possible implementation, the server includes a plurality of interrupt queues, there are a plurality of destination ports that can be used by the service process, and before the interrupt processing core obtains the interrupt processing request, the method further includes: determining, by the service processing core, a correspondence between the plurality of interrupt queues and the plurality of destination ports, where each interrupt queue corresponds to one destination port set, and one destination port set includes a plurality of destination ports; and establishing, by the service processing core, a plurality of TCP connections of the service process by using one destination port set, where the plurality of TCP connections are used to transmit the TCP data packet of the service process. In the foregoing possible implementation, the plurality of TCP connections of the service process are established by using one destination port set, so that the plurality of TCP data packets of the service process can be stored in one interrupt queue. Therefore, the plurality of TCP data packets of the service process are avoided from being stored in a plurality of different interrupt queues.

In another possible implementation, the determining, by the service processing core, a correspondence between the plurality of interrupt queues and the plurality of destination ports includes: obtaining, based on each of the plurality of destination ports and a specified hash value, an interrupt queue corresponding to each destination port, to obtain the correspondence between the plurality of interrupt queues and the plurality of destination ports. In the foregoing possible implementation, the service processing core can simply and effectively determine the correspondence between the plurality of interrupt queues and the plurality of destination ports based on the specified hash value.

In another possible implementation, when types of network interface cards included in the server are different, specified hash values are different. In the foregoing possible implementation, for different servers, when network types of the servers are different, the plurality of TCP data packets of the service process can be stored in one interrupt queue by setting different specified hash values.

According to a second aspect, an interrupt processing apparatus is provided. The apparatus includes: a receiving unit, configured to receive an interrupt processing request, where the interrupt processing request is used to request to process at least one of a plurality of TCP data packets of a service process that are stored in an interrupt queue, and destination ports of all of the plurality of TCP data packets correspond to a same interrupt queue; an obtaining unit, configured to obtain the at least one TCP data packet from the interrupt queue; and a first processing unit, configured to determine a service processing core based on the at least one TCP data packet, where there is cache space shared by the first processing unit and a second processing unit. The first processing unit is further configured to wake the second processing unit, so that the second processing unit processes the at least one TCP data packet.

In a possible implementation, the first processing unit and the second processing unit are a same processing unit; the first processing unit and the second processing unit belong to a same cluster; or the first processing unit and the second processing unit belong to a same logical unit (die).

In another possible implementation, the apparatus includes a plurality of interrupt queues, there are a plurality of destination ports that can be used by the service process, and the second processing unit is further configured to: determine a correspondence between the plurality of interrupt queues and the plurality of destination ports, where each interrupt queue corresponds to one destination port set, and one destination port set includes a plurality of destination ports; and establish a plurality of TCP connections of the service process by using one destination port set, where the plurality of TCP connections are used to transmit the TCP data packet of the service process.

In another possible implementation, the second processing unit is further configured to obtain, based on each of the plurality of destination ports and a specified hash value, an interrupt queue corresponding to each destination port, to obtain the correspondence between the plurality of interrupt queues and the plurality of destination ports.

In another possible implementation, when types of network interface cards included in the interrupt processing apparatus are different, specified hash values are different.

According to a third aspect, a processor is provided. The processor is configured to perform the interrupt processing method provided in any one of the first aspect or the possible implementations of the first aspect.

According to a fourth aspect, a server is provided. The server includes a memory, a processor, a bus, and a communications interface. The memory stores code and data. The processor, the memory, and the communications interface are connected by using the bus. The processor runs the code in the memory, so that the server performs the interrupt processing method provided in any one of the first aspect or the possible implementations of the first aspect.

According to a fifth aspect, a computer-readable storage medium is provided. The computer-readable storage medium stores a computer executable instruction. When at least one processor of a device executes the computer executable instruction, the device performs the interrupt processing method provided in any one of the first aspect or the possible implementations of the first aspect.

According to a sixth aspect, a computer program product is provided. The computer program product includes a computer executable instruction. The computer executable instruction is stored in a computer-readable storage medium. At least one processor of a device may read the computer executable instruction from the computer-readable storage medium. The at least one processor executes the computer executable instruction, so that the device implements the interrupt processing method provided in any one of the first aspect or the possible implementations of the first aspect.

It may be understood that, the apparatus, processor, server, computer storage medium, or computer program product in any interrupt processing method provided above is configured to perform a corresponding method provided above. Therefore, for beneficial effects that can be achieved by the apparatus, processor, server, computer storage medium, or computer program product, refer to the beneficial effects of the corresponding method provided above. Details are not described herein.

### BRIEF DESCRIPTION OF DRAWINGS

FIG. 1 is a schematic diagram of a TCP connection in a distributed data storage system;

FIG. 2 is a schematic structural diagram of a server according to this application;

FIG. 3 is a schematic structural diagram of a processor according to this application;

FIG. 4 is a schematic diagram of data storage in a distributed data storage system according to this application;

FIG. 5 is a schematic flowchart of an interrupt processing method according to this application;

FIG. 6 is a schematic flowchart of another interrupt processing method according to this application;

FIG. 7 is a schematic diagram of a relationship between a service process and an interrupt queue according to this application;

FIG. 8 is a schematic structural diagram of an interrupt processing apparatus according to this application; and

FIG. 9 is a schematic structural diagram of another processor according to this application.

### DESCRIPTION OF EMBODIMENTS

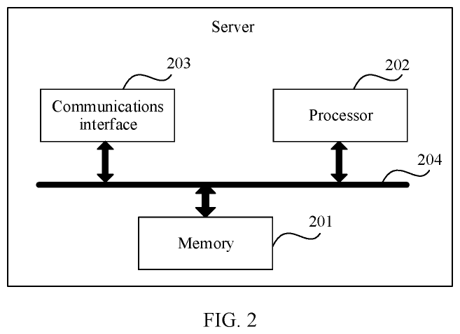

FIG. 2 is a schematic structural diagram of a server according to an embodiment of the present application. Referring to FIG. 2, the server may include a memory 201, a processor 202, a communications interface 203, and a bus 204. The memory 201, the processor 202, and the communications interface 203 are connected to each other by using the bus 204. The memory 201 may be configured to store data, a software program, and a module, and mainly includes a program storage area and a data storage area. The program storage area may store an operating system, an application program required for at least one function, and the like. The data storage area may store data created during use of the device, and the like. The processor 202 is configured to control and manage an action of the server, for example, perform various functions of the server and process data by running or executing the software program and/or the module stored in the memory 201 and by invoking the data stored in the memory 201. The communications interface 203 is configured to support communication of the server.

The processor 202 may be a central processing unit, a general-purpose processor, a digital signal processor, an application-specific integrated circuit, a field programmable gate array or another programmable logic device, a transistor logic device, a hardware component, or any combination thereof. The processor 202 may implement or execute various example logical blocks, modules, and circuits described with reference to content disclosed in this application. Alternatively, the processor 202 may be a combination for implementing a computing function, for example, a combination of one or more microprocessors, or a combination of a digital signal processor and a microprocessor. The bus 204 may be a peripheral component interconnect (PCI) bus, an extended industry standard architecture (EISA) bus, or the like. The bus 204 may be classified into an address bus, a data bus, a control bus, and the like. For ease of representation, only one thick line is used to represent the bus 204 in FIG. 2, but this does not mean that there is only one bus or only one type of bus.

In this embodiment of the present application, a same server may include one or more processors 202, and each processor 202 may include a plurality of cores. For ease of subsequent description, the server in this embodiment of the present application is referred to as a first server.

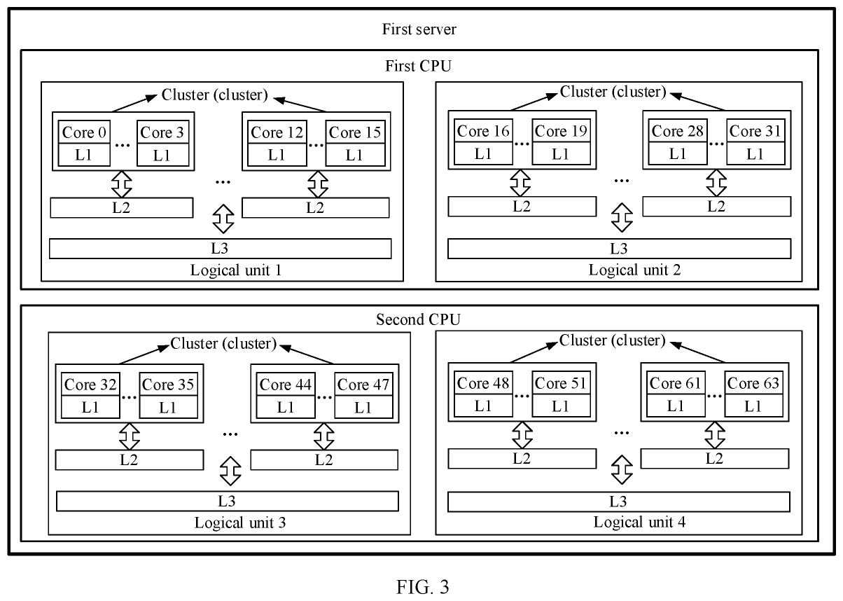

FIG. 3 is a schematic diagram of an internal structure of the processor 202 in the first server. The processor 202 may be an ARM processor, the ARM processor may include a plurality of central processing units (CPU), each CPU may include a plurality of cores (for example, 32 cores), every four cores may be referred to as one cluster, and every four clusters may be referred to as one logical unit (die). In FIG. 3, an example in which the processor 202 includes two CPUs is used for description. In this case, the two CPUs include 64 cores (for example, a core 0 to a core 63), each CPU includes two logical units, and the processor 202 includes four logical units in total. Optionally, a structure of an x86 processor may be extended to the structure of the processor 202 provided in FIG. 3. This is not specifically limited in this application.

According to a data read sequence and a closeness degree of association with a CPU, a CPU cache may be divided into a level 1 cache (L1 cache), a level 2 cache (L2 cache), and a level 3 cache (L3 cache). All data stored in each level of cache is a part of data stored in a next level of cache. The L1 cache is located in a position closest to the CPU, and is a CPU cache closest associated with the CPU. The L1 cache may be used for temporary storage and delivering various types of operation instructions and data required for an operation to a core of the CPU, and has a highest access rate. The L2 cache is located between the L1 cache and the L3 cache. The L2 cache and the L3 cache are merely used to store data that needs to be used during processing of the core of the CPU. An access priority and an access rate of the L2 cache are higher than those of the L3 cache. In addition, capacities of the three levels of caches are sequentially L3, L2, and L1 in descending order.

A working principle of the three levels of caches is as follows: When the core of the CPU needs to read data, the core of the CPU first searches the L1 cache for the data. If the data does not exist in the L1 cache, the core of the CPU needs to search the L2 cache for the data. If the data does not exist in the L2 cache either, the core of the CPU searches the L3 cache for the data. If the data does not exist in the L3 cache either, the core of the CPU needs to read the data from memory. Data stored in the cache is a small part of data in the memory, but the small part of data is to be accessed by the core of the CPU in a short time. When the core of the CPU reads or writes data, data access efficiency is improved by using different caches.

A core of the processor may process an input/output (I/O) operation through interruption, and a specific process is as follows: When a device receives a TCP data packet, the TCP data packet is stored in an interrupt queue. A core (referred to as an interrupt processing core) is configured for each interrupt queue. The interrupt processing core obtains the TCP data packet from the interrupt queue, parses the TCP data packet, and stores data in the TCP data packet in the cache and the memory. Then, a core (which is a core that runs a service process, and is referred to as a service processing core) of a service process corresponding to the TCP data packet reads the data from the cache or the memory of the interrupt processing core, to perform a data read/write operation.

In this embodiment of the present application, when a core needs to access data of another core, if the two cores are located in a same cluster, because a plurality of cores in the same cluster can share one L2 cache, the to-be-accessed data may be transmitted by using the L2 cache. In other words, a first core caches the to-be-accessed data in the L2 cache, and a second core directly accesses the shared L2 cache. Similarly, if the two cores are located in different clusters of a same logical unit, because a plurality of cores in the same logical unit share one L3 cache, the to-be-accessed data may be transmitted by using the L3 cache. In other words, a first CPU core caches the to-be-accessed data in the L3 cache, and a second CPU core directly accesses the shared L3 cache (this may be referred to as cross-logical unit access). If the two cores are not in a same CPU, the to-be-accessed data can be transmitted by using only the memory. In other words, a first core stores the to-be-accessed data in the memory of the first core, and a second core reads the data from the memory of the first core (this may be referred to as cross-CPU access). In this case, a transmission process needs to be completed by crossing a plurality of CPUs by using an internal bus. An access delay of the L3 cache is longer than an access delay of the L2 cache, and an access delay of the memory is longer than the access delay of the L3 cache. Therefore, when the two cores are in a case of cross-logical unit access or a case of cross-CPU access, there is a problem of a long access delay.

The interrupt processing method provided in the embodiments of the present application is applicable to all servers that transmit data packets by using TCP connections. For example, the server may be a server in a distributed data storage system. For ease of subsequent description, the following uses the distributed data storage system as an example for description.

The distributed data storage system may include a plurality of servers. In the distributed data storage system, data of a user may be stored in a form of a plurality of pieces of replica data. A plurality of pieces of replica data of same data may be stored on different servers. When the user performs an I/O operation on the data stored on the server, consistency of the plurality of pieces of replica data of the same data needs to be ensured. The plurality of pieces of replica data may be master backup data and a plurality of pieces of slave backup data.

The user may access, by using a server on which a virtual block system (VBS) process is deployed, replica data in a server on which an object storage device (OSD) process is deployed. A plurality of OSD processes may be deployed on one server, each OSD process corresponds to one disk on the server, and the disk may store a plurality of pieces of different replica data. The VBS process is an I/O process of a service, and is used to provide an access point service (to be specific, user data is presented in a form of a virtual block, and real data can be accessed by accessing the virtual block). The VBS process may be further used to manage volume (volume) metadata. The user data may be stored in a form of a volume. The volume metadata may be related information used to describe a distribution status of the user data in a storage server, for example, an address of the data, a modification time of the data, or permission of accessing the data. The OSD process is also an I/O process of the service, is used to manage user data stored in a corresponding disk, and may be further used to perform a specific I/O operation, that is, used to perform a specific data read/write operation.

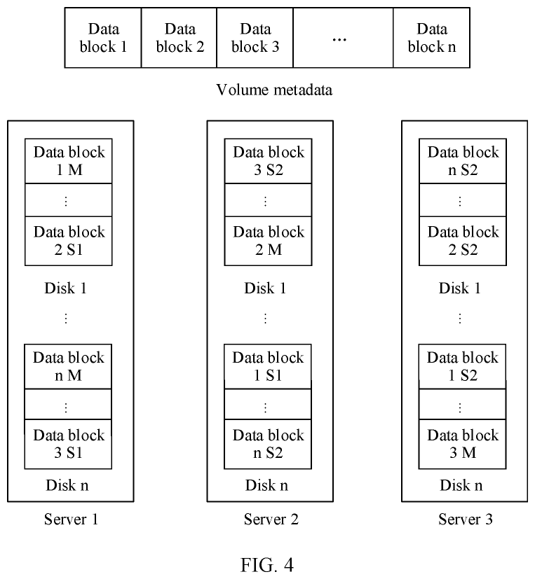

For ease of understanding, an example in which the distributed data storage system includes three servers configured to store user data and the user data stored in the system is a three-replica model is used herein for description. A schematic diagram of storage of the user data in the server may be shown in FIG. 4. The three-replica model means that three pieces of replica data of each data block are stored in the storage system. One piece of replica data may be master backup data, and the other two pieces of replica data may be slave backup data. The VBS process may slice the user data stored in the server. If n data blocks, namely, a part 1 to a part n, are obtained after slicing, and three pieces of replica data of each data block are stored, a storage structure of the three pieces of replica data of each of the n data blocks part 1 to part n may be shown in FIG. 4. Three pieces of backup data of each data block are distributed in disks of different servers. In FIG. 4, M is used to represent a master part of each data block, S1 is used to represent a slave 1 part of each data block, and S2 is used to represent a slave 2 part of each data block. It is assumed that each server includes n disks, namely, a disk 1 to a disk n. Volume metadata in FIG. 4 is volume metadata of the part 1 to the part n managed by the VBS process. The volume metadata may include identifier information of a server storing each data block and a specific location of the data block in the server.

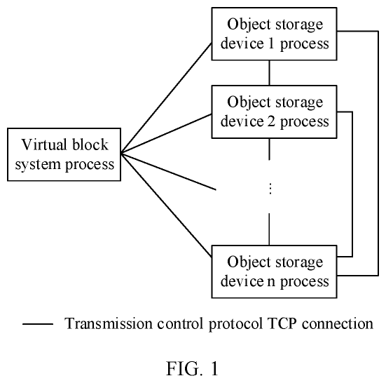

In addition, as shown in FIG. 1, when data transmission is performed between a VBS process and an OSD process that are in different servers, and between OSD processes that are in different servers, the VBS process needs to establish a transmission control protocol (TCP) connection to each OSD process deployed in the server, and a TCP connection also needs to be established between the OSD processes in the different servers. A TCP data packet may be transmitted by using the established TCP connection. In FIG. 1, an example in which an OSD 1 to an OSD n represent the OSD processes in the different servers is used for description.

Because different backup data (Master and Slave) of a same data block is stored on different servers, when an input/output (I/O) operation is performed on one piece of data, consistency of other backup data needs to be ensured. Specifically, when the VBS process performs an I/O operation on user data stored in the server, the VBS process may query volume metadata, to determine servers on which three pieces of replica data of a data block operated through the I/O operation are located and specific locations of the three pieces of replica data on the server. The VBS process sends a TCP data packet to an OSD process in a server on which a master part of the data block is located, and the OSD process stores data in the TCP data packet. Then, the OSD process separately sends, by using TCP connections, the received data to OSD processes in servers corresponding to two slave parts, so that a plurality of pieces of replica data of the data keep consistent. Then, after receiving response information sent by the OSD processes in the servers corresponding to the two slave parts, the OSD process in the server corresponding to the master part returns response information to the VBS process, to complete the I/O operation.

For an OSD process, the OSD process may receive a TCP data packet from the VBS process, or may receive a TCP data packet from an OSD process on another server. Therefore, the OSD process may receive a plurality of TCP data packets. Correspondingly, with reference to the foregoing principle in which a core of a processor processes one TCP data packet, when a server receives a plurality of TCP data packets, the plurality of TCP data packets may be stored in a plurality of different interrupt queues. The plurality of interrupt queues correspond to a plurality of interrupt processing cores. In this case, an interrupt processing core in each interrupt queue obtains a corresponding TCP data packet from the interrupt queue, parses the TCP data packet, and stores data in the corresponding TCP data packet in a cache and memory of the interrupt processing core.

Because the interrupt processing core in each interrupt queue is randomly configured, the plurality of interrupt processing cores corresponding to the plurality of interrupt queues may be distributed in different logical units and different CPUs. In this case, when reading data in a plurality of TCP data packets, a service processing core needs to read the data from different caches and memory. An access delay of memory and an access delay of an L3 cache are longer than an access delay of an L2 cache. Therefore, the service processing core has a problem of a long data access delay. This reduces a user data processing rate and affects system performance.

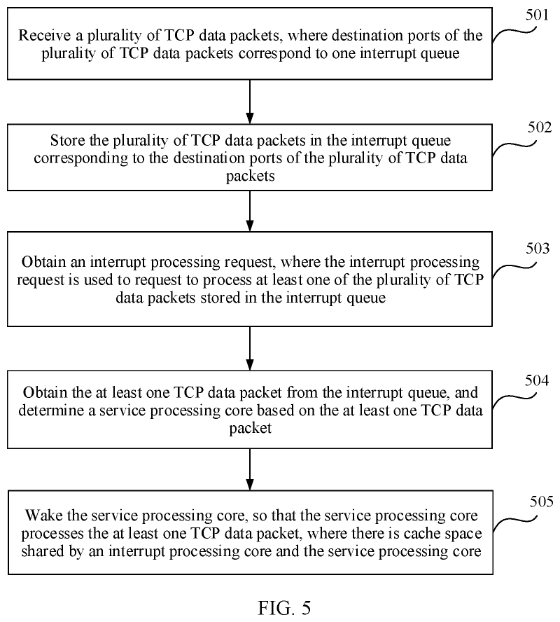

FIG. 5 is a flowchart of an interrupt processing method according to an embodiment of the present application. The method is applied to a server of a CPU including a plurality of cores. The CPU of the plurality of cores includes an interrupt processing core and a service processing core. The service processing core is a core that runs a service process. The service processing core may be configured to process a data read/write operation related to the service process. For example, the service process may be an OSD process, a core that runs the OSD process is referred to as the service processing core, and the service processing core may be configured to process a read/write operation on backup data managed by the OSD process. The interrupt processing core is a core configured to process an interrupt, and the server may configure one interrupt processing core for one interrupt queue. Correspondingly, the method includes the following a plurality of steps.

Step 501: A first server receives a plurality of TCP data packets, where destination ports of the plurality of TCP data packets correspond to one interrupt queue.

Herein, that the server is the first server is used as an example. The first server may include a plurality of service processes, and each service process may be used to manage backup data of a plurality of data blocks. The backup data may include master data, and may include slave data, and the master data and the slave data are backups of different data blocks. In this embodiment of the present application, one service process of the first server is used as an example for description. TCP connections may be established between the service process and a plurality of processes of other different servers. The TCP connection is used to transmit a TCP data packet. For example, in a distributed data storage system, the service process may be an OSD process. A TCP connection may be established between the OSD process and a VBS process, or TCP connections may be established between the OSD process and a plurality of OSD processes of other servers.

In the distributed data storage system, when a user performs a write operation, if master data of a data block corresponding to the write operation is in user data managed by an OSD process of the first server, the user may send a TCP data packet by using a TCP connection between a VBS process and the OSD process of the first server. Alternatively, when another server needs to synchronize replica data, if corresponding slave data is in the user data managed by the OSD process of the first server, the another server may send a TCP data packet by using a TCP connection between a corresponding OSD process and the OSD process. Therefore, the first server may receive a plurality of TCP data packets, and specifically, may receive the plurality of TCP data packets by using a communications interface. The plurality of TCP data packets may include a TCP data packet from the VBS process, or may include a TCP data packet from an OSD process in another server.

Each of the plurality of TCP data packets includes port information, and the port information may be used to indicate a destination port of the TCP data packet. For example, the TCP data packet may include four-tuple information, that is, a source IP address, a source port, a destination IP address, and a destination port. The destination port indicated by the port information in the TCP data packet may be the destination port in the four-tuple information.

It should be noted that the destination port in this application is a communications protocol port facing a connection service, may also be referred to as a TCP port, and is an abstract software structure instead of a hardware port.

Step 502: The first server stores the plurality of TCP data packets in the interrupt queue corresponding to the destination ports of the plurality of TCP data packets.

Specifically, when the first server receives the plurality of TCP data packets, for each of the plurality of TCP data packets, a network interface card driver of the first server may obtain four-tuple information in the TCP data packet. The four-tuple information may include port information. When performing a hash operation based on the four-tuple information and a specified hash value, the network interface card driver may shield other information in the four-tuple information (for example, all bits corresponding to information other than a destination port in the four-tuple information are set to 0 in a hash operation process), and only reserve the destination port. After the hash operation, an operation result of a specific length (for example, 32 bits) is obtained. The network interface card driver may search an ethernet queue array (e.g.: indirection table) based on a value corresponding to a specified length (for example, 8 bits) in the operation result. Each value in the array may be an ethernet queue index, and is used to represent one ethernet queue. An ethernet queue indicated by a found ethernet queue index is the interrupt queue in which the TCP data packet is stored.

It should be noted that the specified hash value may be set in advance. When network interface card drivers in the first server are different, corresponding specified lengths and ethernet queue arrays may be different. Therefore, when types of network interface cards in the first server are different, corresponding specified hash values are different. This is not specifically limited in this embodiment of the present application.

Further, because the destination ports of the plurality of TCP data packets correspond to one interrupt queue, after processing is performed according to the foregoing method, the plurality of TCP data packets are stored in one interrupt queue. A reason why the destination ports of the plurality of TCP data packets correspond to one interrupt queue is that screening is performed on a to-be-used TCP port when a plurality of TCP connections of the service process are established. Details are as follows:

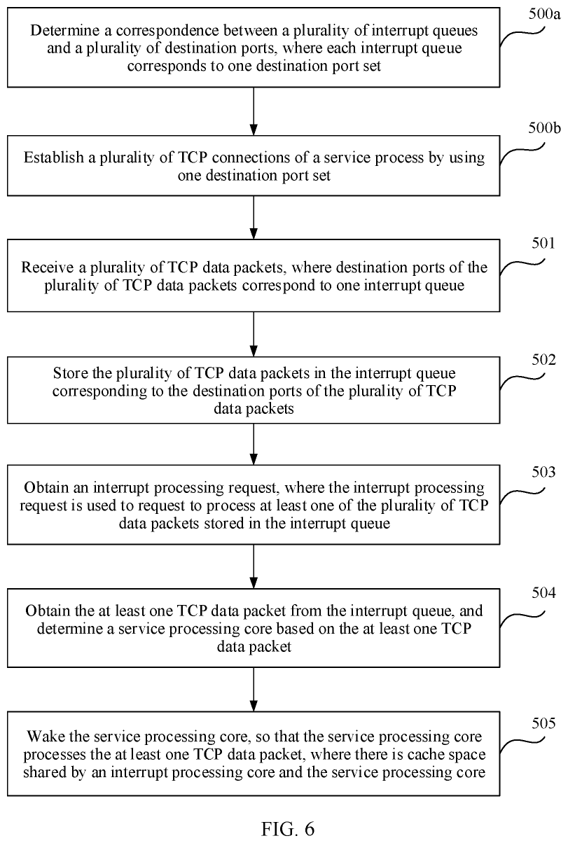

The first server may include a plurality of interrupt queues. The plurality of interrupt queues may also be referred to as ethernet queues. There are a plurality of destination ports that can be used by the service process. Correspondingly, referring to FIG. 6, that the first server establishes the plurality of TCP connections of the service process includes step 500a and step 500b.

Step 500a: The first server determines a correspondence between the plurality of interrupt queues and the plurality of destination ports, where each interrupt queue corresponds to one destination port set, and one destination port set may include a plurality of destination ports.

Specifically, the correspondence between the plurality of interrupt queues and the plurality of destination ports may be determined by a service processing core of the first server. This may include: determining, based on each of the plurality of destination ports and a specified hash value, an interrupt queue corresponding to each destination port; and using a plurality of destination ports corresponding to one interrupt queue as one destination port set corresponding to the interrupt queue, so as to obtain the correspondence between the plurality of interrupt queues and the plurality of destination ports.

Optionally, the correspondence between the plurality of interrupt queues and the plurality of destination ports may also be referred to as a correspondence between an interrupt queue and a port set.

For ease of understanding, an example in which the first server includes nine interrupt queues and indexes of the nine interrupt queues are respectively q1 to q9 is used for description herein. For each of the plurality of destination ports that can be used by the service process, a method for determining an interrupt queue corresponding to the destination port may be as follows: A hash operation is performed based on the destination port and the specified hash value, to determine a value in a specified length. If the specified length is 8 bits, an 8-bit value corresponding to the destination port is 12. When an ethernet queue array shown in the following Table 1 is queried based on the value 12, a corresponding interrupt queue index is determined as q4.

TABLE 1

| Value in a specified length | Interrupt queue index |
|---|---|
| 0, 9, 18, 27 . . . | q1 |
| 1, 10, 19, 28 . . . | q2 |
| 2, 11, 20, 29 . . . | q3 |
| 3, 12, 21, 30 . . . | q4 |
| . . . | . . . |

It should be noted that the ethernet queue array shown in Table 1 and the foregoing manner of determining the correspondence between the plurality of destination ports and the plurality of interrupt queues are merely examples, and do not constitute a limitation on this application.

Step 500b: The first server establishes the plurality of TCP connections of the service process by using the plurality of destination ports included in one destination port set. The plurality of TCP connections may be used to transmit a TCP data packet of the service process.

Specifically, the service processing core of the first server may establish the plurality of TCP connections of the service process. Because a plurality of ports in a port set corresponding to one interrupt queue are used when the plurality of TCP connections of the service process are established, the destination ports of the plurality of TCP data packets received by the first server correspond to one interrupt queue, so that the plurality of TCP data packets can be mapped to one interrupt queue.

Step 503: The first server obtains an interrupt processing request, where the interrupt processing request is used to request to process at least one of the plurality of TCP data packets stored in the interrupt queue, and the destination ports of the plurality of TCP data packets correspond to the interrupt queue.

The first server may configure one interrupt processing core for each interrupt queue. After the plurality of TCP data packets are stored in the interrupt queue, a peripheral component (for example, a network interface card module of the server) of the server may send the interrupt processing request to the interrupt processing core corresponding to the interrupt queue. The interrupt processing request may be used to request to process one TCP data packet stored in the interrupt queue, or used to request to process a plurality of TCP data packets stored in the interrupt queue. In other words, the interrupt processing request may be used to request to process the at least one TCP data packet.

Step 504: The first server obtains the at least one TCP data packet from the interrupt queue, and determines a service processing core based on the at least one TCP data packet.

Specifically, this may be performed by the interrupt processing core. When the interrupt processing core receives the interrupt processing request, the interrupt processing core may obtain the at least one TCP data packet from the interrupt queue, parses the TCP data packet, stores data of the at least one TCP data packet in a cache and memory, and determines the service process based on TCP connection information of the at least one TCP data packet, so as to determine the service processing core.

Step 505: The first server wakes the service processing core, so that the service processing core processes the at least one TCP data packet, where there is cache space shared by the interrupt processing core and the service processing core.

After the interrupt processing core determines the service processing core, the interrupt processing core may wake the service processing core. For example, the interrupt processing core may send a wake-up instruction to the service processing core. When the service processing core receives the wake-up instruction, the service processing core is woken. Because there is the cache space shared by the interrupt processing core and the service processing core, the service processing core may read the data of the at least one TCP data packet from the cache of the interrupt processing core, to implement a data operation on the at least one TCP data packet. For example, original data stored in the server is updated based on the data in the TCP data packet, and user data in the TCP data packet is sent to another server, so that the another server updates stored original data.

That there is the cache space shared by the interrupt processing core and the service processing core may include: The interrupt processing core and the service processing core are a same core, or the interrupt processing core and the service processing core meet either of the following conditions: being located in a same cluster (cluster), or being located in a same logical unit (die).

Specifically, with reference to the processor structure shown in FIG. 3, when the interrupt processing core and the service processing core are the same core, to-be-accessed data may be transmitted by using an L1 cache. A transmission process may be as follows: The interrupt processing core temporarily stores the data of the at least one TCP data packet in the L1 cache, and the service processing core directly accesses the L1 cache.

When the interrupt processing core and the service processing core are located in the same cluster, because a plurality of cores in the same cluster share one L2 cache, to-be-accessed data may be transmitted by using the L2 cache. A transmission process may be as follows: The interrupt processing core temporarily stores the data of the at least one TCP data packet in the L2 cache, and the service processing core directly accesses the L2 cache.

When the interrupt processing core and the service processing core are located in different clusters of the same logical unit, because a plurality of cores in the same logical unit share one L3 cache, to-be-accessed data may be transmitted by using the L3 cache. A transmission process may be as follows: The interrupt processing core temporarily stores the data of the at least one TCP data packet in the L3 cache, and the service processing core directly accesses the L3 cache.

Optionally, when the first server includes two or more CPUs, an interrupt CPU core and a service CPU core may be configured in different clusters of a same CPU. In this way, compared with a case in which two CPU cores are located in different CPUs, a part of a data access delay can be reduced, and a data processing rate can be improved. Because cache access rates are L1>L2>L3>cross-die memory access>cross-CPU memory access, the interrupt processing core and the service processing core may be configured as the same core as much as possible, may be configured in the same cluster (cluster), or may be configured in the same logical unit (die), to reduce the data access delay, and improve the data processing rate.

For example, in a distributed data storage system, when a plurality of TCP connections of an OSD process in the first server correspond to different interrupt queues, and a service processing core that runs a service process and an interrupt processing core of each interrupt queue are located in different clusters or CPUs, the service processing core and a plurality of interrupt processing cores may be probably distributed in different CPUs or different clusters. Consequently, a data processing delay of the processing core is relatively long.

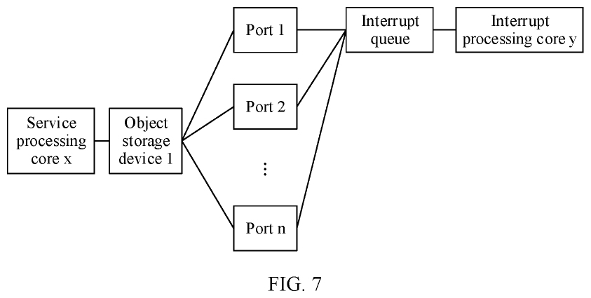

However, in this embodiment of the present application, when different destination ports of the service process in the first server correspond to one interrupt queue, and the service processing core that runs the service process and the interrupt processing core of the interrupt queue are located in the same cluster or the same logical unit, a relationship between the service processing core and the interrupt processing core may be shown in FIG. 7. In FIG. 7, a core x represents a service processing core, and an OSD 1 represents a service process that is run on the core x. A port 1 to a port n (port 1 to port n) represent a plurality of destination ports. Ethq 0 represents an interrupt queue corresponding to the plurality of destination ports. A core y represents an interrupt processing core of the interrupt queue. The core x and the core y in FIG. 7 may be located in a same cluster or a same logical unit, or the core x and the core y may be a same core.

In the interrupt processing method provided in this embodiment of the present application, through configuration, the plurality of TCP connections of the service process in the server correspond to one interrupt queue, so that the plurality of TCP data packets received by the service process through the plurality of TCP connections may be stored in one interrupt queue. In addition, through configuration, there is the same cache space between the interrupt processing core of the interrupt queue and the service processing core that runs the service process, so that the service processing core can use a shared cache to access data. This reduces a data access delay, and improves data processing efficiency, so that system performance is improved.

The foregoing mainly describes the solutions in the embodiments of the present application from a perspective of the server. It may be understood that, to achieve the foregoing functions, the server includes a corresponding hardware structure and/or software module for implementing each function. A person skilled in the art should be easily aware that, in combination with examples of devices and algorithm steps described in the embodiments disclosed in this specification, the embodiments of the present application may be implemented in a hardware form or a form of a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In the embodiments of this application, the server may be divided into function modules based on the foregoing method examples. For example, each function module may be obtained through division based on each corresponding function, or two or more functions may be integrated into one processing module. The integrated module may be implemented in a form of hardware, or may be implemented in a form of a software function module. It should be noted that in the embodiments of this application, division into the modules is an example, and is merely logical function division. There may be another division manner in actual implementation.

When each function module is obtained through division by using each corresponding function, FIG. 8 is a possible schematic structural diagram of an interrupt processing apparatus in the foregoing embodiments. The interrupt processing apparatus includes a receiving unit 801, an obtaining unit 802, a first processing unit 803, and a second processing unit 804. The receiving unit 801 is configured to perform step 501 in FIG. 5 or FIG. 6, and is further configured to perform step 503 in FIG. 5 or FIG. 6. The obtaining unit 802 and the first processing unit 803 are configured to perform step 504 in FIG. 5 or FIG. 6. The first processing unit 803 and the second processing unit 804 are configured to perform step 505 in FIG. 5 or FIG. 6, another technical process described in this specification, and the like. The foregoing interrupt processing apparatus may also be a server. All related content of steps in the method embodiment may be cited in function descriptions of a corresponding function module. Details are not described herein again.

In hardware implementation, the receiving unit 801 and the obtaining unit 802 may be a communications interface, and the first processing unit 803 and the second processing unit 804 may be a processor.

When the interrupt processing apparatus shown in FIG. 8 may also implement the interrupt processing method in FIG. 5 or FIG. 6 by using software, the interrupt processing apparatus and modules of the interrupt processing apparatus may also be software modules.

FIG. 2 is a schematic diagram of a possible logical structure of the server in the foregoing embodiments according to the embodiments of the present application. A processor 202 in the server may include a plurality of cores. The plurality of cores may be a plurality of cores in one CPU, or may be a plurality of cores in a plurality of CPUs. The plurality of cores may include an interrupt processing core and a service processing core. The interrupt processing core is configured to perform the operations in step 501 to step 505 in FIG. 5 or FIG. 6. The service processing core is configured to perform the operations in step 500a and step 500b in FIG. 6.

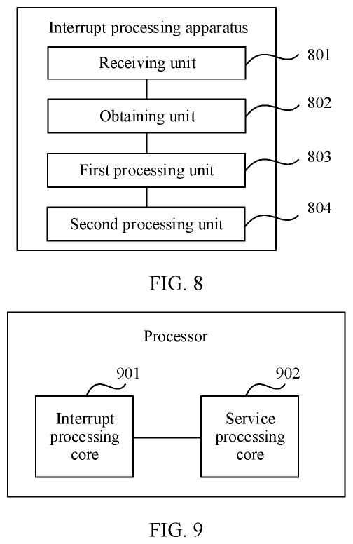

In another embodiment of this application, as shown in FIG. 9, a processor is further provided. The processor may include a plurality of cores. The plurality of cores include an interrupt processing core 901 and a service processing core 902. The processor may be configured to perform the interrupt processing method provided in FIG. 5 or FIG. 6. The interrupt processing core 901 and the service processing core 902 may be a same core. Alternatively, the interrupt processing core 901 and the service processing core 902 may belong to a same cluster. Alternatively, the interrupt processing core 901 and the service processing core 902 may belong to a same logical unit. In FIG. 9, an example in which the interrupt processing core 901 and the service processing core 902 are two different cores is used for description.

All or some of the foregoing embodiments may be implemented by software, hardware, firmware, or any combination thereof. When the software is used to implement the embodiments, the foregoing embodiments may be implemented completely or partially in a form of a computer program product. The computer program product includes one or more computer instructions. When the computer program instructions are loaded or executed on a computer, the procedures or functions according to the embodiments of the present application are all or partially generated. The computer may be a general-purpose computer, a dedicated computer, a computer network, or another programmable apparatus. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, including one or more usable medium sets. The usable medium may be a magnetic medium (for example, a floppy disk, a hard disk, or a magnetic tape), an optical medium (for example, a DVD), a semiconductor medium, or the like. The semiconductor medium may be a solid-state drive (SSD).

In another embodiment of this application, a chip system is further provided. The chip system includes a processor, a memory, a communications interface, and a bus. The processor, the memory, and the communications interface are connected by using the bus. The memory stores code and data. When the processor runs the code in the memory, the chip system is enabled to perform the interrupt processing method provided in FIG. 5 or FIG. 6.

In this application, through configuration, a plurality of TCP connections of a service process in a server correspond to one interrupt queue, so that a plurality of TCP data packets received by the service process through the plurality of TCP connections may be stored in one interrupt queue. In addition, through configuration, there is same cache space between an interrupt processing core of the interrupt queue and a service processing core that runs the service process, so that the service processing core can use a shared cache to access data. This reduces a data access delay, and improves data processing efficiency, so that system performance is improved.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. An interrupt processing method, applied in a server of a central processing unit (CPU) comprising a plurality of cores, wherein the plurality of cores comprises an interrupt processing core and a service processing core that runs a service process, and the method comprising:
obtaining, by the interrupt processing core, an interrupt processing request, wherein the interrupt processing request is used to request to process at least one of a plurality of transmission control protocol (TCP) data packets of the service process that are stored in an interrupt queue, and destination ports of all of the plurality of TCP data packets correspond to a same interrupt queue;
obtaining, by the interrupt processing core, the at least one TCP data packet from the interrupt queue;
identifying, by the interrupt processing core, the service processing core based on the at least one TCP data packet; and
waking, by the interrupt processing core, the service processing core, so that the service processing core processes the at least one TCP data packet.

2. The method according to claim 1, wherein the interrupt processing core and the service processing core are a same core in one CPU.

3. The method of claim 2, wherein the service processing core and the interrupt processing core belong to a same cluster.

4. The method of claim 2, wherein the service processing core and the interrupt processing core belong to a same logical unit.

5. The method of claim 1, wherein the interrupt processing core and the service processing core share a cache space.

6. The method according to claim 1, wherein the server comprises a plurality of interrupt queues, wherein a plurality of destination ports can be used by the service process, and before the obtaining, by the interrupt processing core, an interrupt processing request, the method further comprises:
identifying, by the service processing core, a correspondence between the plurality of interrupt queues and the plurality of destination ports, wherein each interrupt queue of the plurality of interrupt queues corresponds to one destination port set, and one destination port set comprises a plurality of destination ports; and
establishing, by the service processing core, a plurality of TCP connections of the service process using one destination port set, wherein the plurality of TCP connections are used to transmit the TCP data packet of the service process.

7. The method according to claim 6, wherein the identifying, by the service processing core, a correspondence between the plurality of interrupt queues and the plurality of destination ports comprises:
obtaining, based on each of the plurality of destination ports and a specified hash value, an interrupt queue corresponding to each destination port, to obtain the correspondence between the plurality of interrupt queues and the plurality of destination ports.

8. The method according to claim 7, wherein when types of network interface cards comprised in the server are different, specified hash values are different.

9. A processor, wherein the processor comprises a plurality of cores, the plurality of cores comprise an interrupt processing core and a service processing core, wherein:
the interrupt processing core is configured to: obtain an interrupt processing request, wherein the interrupt processing request is used to request to process at least one of a plurality of transmission control protocol (TCP) data packets of the service process that are stored in an interrupt queue, and destination ports of all of the plurality of TCP data packets correspond to a same interrupt queue; obtain the at least one TCP data packet from the interrupt queue; identify the service processing core based on the at least one TCP data packet; and wake the service processing core; and
the service processing core is configured to: process the at least one TCP data packet.

10. The processor of claim 9, wherein the interrupt processing core and the service processing core are a same core in one CPU.

11. The processor of claim 10, wherein the service processing core and the interrupt processing core belong to a same cluster.

12. The processor of claim 10, wherein the service processing core and the interrupt processing core belong to a same logical unit.

13. The processor of claim 9, wherein the interrupt processing core and the service processing core share a cache space.

14. The processor of claim 9, wherein
the service processing core is further configured to: identify a correspondence between the plurality of interrupt queues and the plurality of destination ports, wherein each interrupt queue of the plurality of interrupt queues corresponds to one destination port set, and one destination port set comprises a plurality of destination ports; and
establish a plurality of TCP connections of the service process using one destination port set, wherein the plurality of TCP connections are used to transmit the TCP data packet of the service process.

15. The processor of claim 14, wherein
the service processing core is further configured to: obtain, based on each of the plurality of destination ports and a specified hash value, an interrupt queue corresponding to each destination port, to obtain the correspondence between the plurality of interrupt queues and the plurality of destination ports.

16. The processor of claim 9, wherein when types of network interface cards comprised in the server are different, specified hash values are different.

17. A non-transitory computer-readable storage medium comprising instructions which, when executed by a computer, cause the computer to carry out the steps of:
obtaining an interrupt processing request, wherein the interrupt processing request is used to request to process at least one of a plurality of transmission control protocol (TCP) data packets of the service process that are stored in an interrupt queue, and destination ports of all of the plurality of TCP data packets correspond to a same interrupt queue;
obtaining the at least one TCP data packet from the interrupt queue;
identifying the service processing core based on the at least one TCP data packet; and
waking the service processing core, so that the service processing core processes the at least one TCP data packet.

18. The non-transitory computer-readable storage medium of claim 17, wherein the interrupt processing core and the service processing core are a same core in one CPU.

19. The non-transitory computer-readable storage medium of claim 18, wherein the service processing core and the interrupt processing core belong to a same cluster.

20. The non-transitory computer-readable storage medium of claim 18, wherein the service processing core and the interrupt processing core belong to a same logical unit.
